(19) United States
(12) Patent Application Publication
(10) Pub. No.: US 2022/0206890 A1
(43) Pub. Date: Jun. 30, 2022

(54) VIDEO PLAYBACK ERROR IDENTIFICATION BASED ON EXECUTION TIMES OF DRIVER FUNCTIONS

(71) Applicant: Hewlett-Packard Development Company, L.P., Spring, TX (US)

(72) Inventor: Hsiang-Ta Ke, Taipei City (TW)

(73) Assignee: Hewlett-Packard Development Company, L.P., Spring, TX (US)

(21) Appl. No.: 17/606,528

(22) PCT Filed: Jul. 30, 2019
(86) PCT No.: PCT/US2019/044157

§ 371 Date: Oct. 26, 2021

(51) Int. Cl. G06F 11/07; G06F 11/34; H04N 21/4425

(52) U.S. Cl. CPC G06F 11/0757; H04N 21/4425; G06F 11/3476; G06F 11/0772

(57) ABSTRACT

According to examples, an apparatus may include a processor and a non-transitory computer-readable medium on which may be stored instructions that when executed by the processor, may cause the processor to access a data file. In some examples, the data file may include a frame rate of a video and information regarding driver functions associated with driver threads executing during playback of the video. In some examples, the processor may determine whether the frame rate is less than a predefined frame rate. When frame rate is determined to be less than the predefined frame rate, the processor may determine whether an execution time of a first driver function exceeds a first predefined length of time. In some examples, the processor may output a first error message that includes information associated with the first driver function.

### BACKGROUND

Electronic devices, such as computing devices, may be used for playback of videos. The electronic devices may include operating systems that may facilitate execution of programs for rendering the videos for playback. In some examples, the programs may render the videos at particular frame rates.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example apparatus that may determine a cause of a video glitch and may output an error message that includes information associated with the cause of the video glitch;

FIG. 2 shows a block diagram of an example system in which the example apparatus depicted in FIG. 1 may be implemented;

FIG. 3 shows a flow diagram of an example method for generating a data file for determining a first driver function in a first driver thread to be associated with a frame rate of a video playback that is less than a predefined frame rate, e.g., determining a cause of a video glitch in a playback of the video;

FIG. 4 shows a flow diagram of an example method for determining a driver function or multiple driver functions to be associated with a frame rate of a video playback that is less than a predefined frame rate, e.g., determining a cause of a video glitch in a playback of the video; and

FIG. 5 shows a block diagram of a non-transitory computer-readable medium that may have stored thereon machine-readable instructions for determining a driver function or multiple driver functions to be associated with a frame rate of a video playback that is less than a predefined frame rate, e.g., determining a cause of a video glitch in a playback of the video.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Glitches in video during playback, e.g., sudden and/or irregular drops in video playback frame rate, may be distracting to a user and may degrade the user experience. The effects of the glitches may be even more noticeable for high definition video rendering devices such as in, for example, virtual reality (VR) devices. Identifying the causes of the glitches quickly and efficiently may facilitate improved operation of the video rendering device and the user experience. In general, two major factors that may contribute to glitches may be the frame rate of a video during playback and operations of an operating system (OS) of a computing device that is rendering the video.

A frame rate may be defined as the frequency at which frames in a video are displayed. The human eye is sensitive to video glitches when the frame rate is less than around 30 frames per second (fps). In many applications, such as for VR devices, a frame rate of 60 fps may be used, for example, to improve video quality as well as to reduce certain side effects such as dizzying effects. In some examples, a sudden drop in the frame rate or a drop in the frame rate below a certain threshold may coincide with a noticeable glitch in the video during playback. As such, the frame rate during playback of the video may be a major factor in the cause of glitches.

In addition to the frame rate, normal OS operations may also be a major factor in the cause of glitches during playback of a video. While video glitches in the computing device may be caused by many different sources, in many instances, the source of glitches may be the OS itself, rather than hardware or software resources specific to the rendering of the video such as a graphical processor unit (GPU) or a video codec. In particular examples, an OS may simultaneously execute multiple processes, together with the processes specific to rendering the video. During normal operations, the OS may process various driver functions, which may interrupt other processes that are concurrently executing, and the OS may prioritize and handle these requests while the video is being rendered. These interruptions to the video rendering processes may in certain cases cause glitches during playback of the video.

As used herein, “driver functions” may refer to OS functions such as, for example, interrupt service routines (ISR), deferred procedure calls (DPC), and/or the like. An ISR, also known as an interrupt handler, is a code in the OS for handling a specific interrupt condition, which hardware or software, such as a third party device driver, may initiate. The ISR may be used to handle high-priority conditions by interrupting a currently executing low-priority process to address the high-priority condition. A DPC is a mechanism of an OS to prioritize various tasks within the OS, and the DPC may allow a lower priority task to be deferred in favor of a high-priority task, e.g., to cause an ISR for a third party device driver to interrupt a process for video rendering.

In some examples, as the OS processes the driver functions (e.g., ISR and DPC), the durations and frequencies of these driver functions may cause video glitches. For example, when a duration/length for executing a particular driver function in a driver thread lasts longer than a predefined length of time, a longer than acceptable interruption in video rendering may cause a video glitch. Likewise, in some examples, when a plurality of driver functions are processed in a relatively short time period, the interruption in video rendering caused by a sum of execution times for each of the plurality of driver functions may cause a video glitch. As such, driver functions (e.g., ISR and/or DPC) initiated by the OS during playback of the video may be a major factor in the cause of glitches. However, because the OS may initiate a large number of driver functions in a large number of threads during playback, it may be difficult to identify specific driver functions that may be associated with a video glitch.

Disclosed herein are apparatuses, methods, and computer-readable mediums for identifying causes of a video glitch in a computing device, and in particular, identifying driver functions of an OS that may be the cause of the video glitches. In some examples, a logging function of the OS may be used to generate a log file (e.g., event logs) that may include a frame rate during playback of the video and information on the driver functions associated with a plurality of driver threads executing during playback of the video. The event log may be translated into a data file having a text format that may facilitate analysis of the data.

By way of example, a processor may determine two types of conditions caused by device drivers, e.g., “long” interrupts and “heavy” interrupts. For determining long interrupts, the processor may access the data file and identify driver functions associated with interrupts by first determining whether a frame rate during playback is less than a predefined frame rate. By way of particular example, the predefined frame rate may be set to a minimum frame rate at which the user is not likely to notice a glitch in the video, e.g., 60 fps. When the frame rate is determined to be less than the predefined frame rate, the processor may determine whether an execution time of a driver function exceeds a first predefined length of time, and if such a driver function is identified, an error message may be output including information regarding the identified driver function.

For determining heavy interrupts, by way of example, the processor may access the data file and identify driver functions associated with interrupts by first determining whether the frame rate during playback is less than the predefined frame rate, and in such as case, the processor may determine whether a sum of execution times of a plurality of driver functions in a driver thread exceeds a second predefined length of time within a predefined time period. Upon detection of such a condition, the processor may output an error message including information regarding the identified driver functions. The error messages for both the long interrupts and heavy interrupts may facilitate quick and efficient identification by the user of the specific driver functions, and thus the associated device drivers that may be the cause of the video glitches.

Through implementation of the features of the present disclosure, potential causes of video playback glitches may be identified quickly and efficiently. By quickly identifying the potential causes, the potential causes of the video playback glitches may be corrected quickly, which may improve playback of the video. As a result, machines that perform the playback may be maintained at intended operational levels for longer periods of time, which may result in the machines operating in smooth and efficient manners. Additionally, playing back video without glitches may result the video being played back a fewer number of times, which may reduce or minimize energy consumed in playing the video.

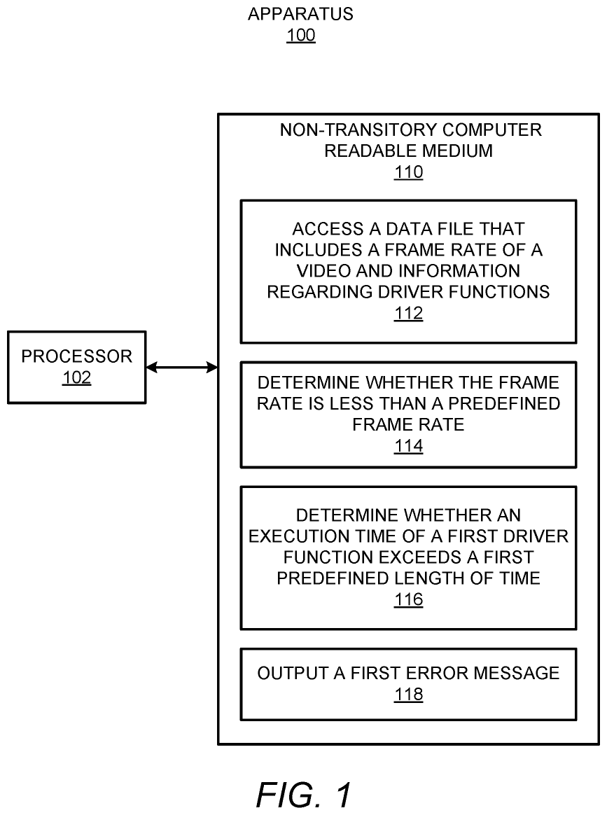

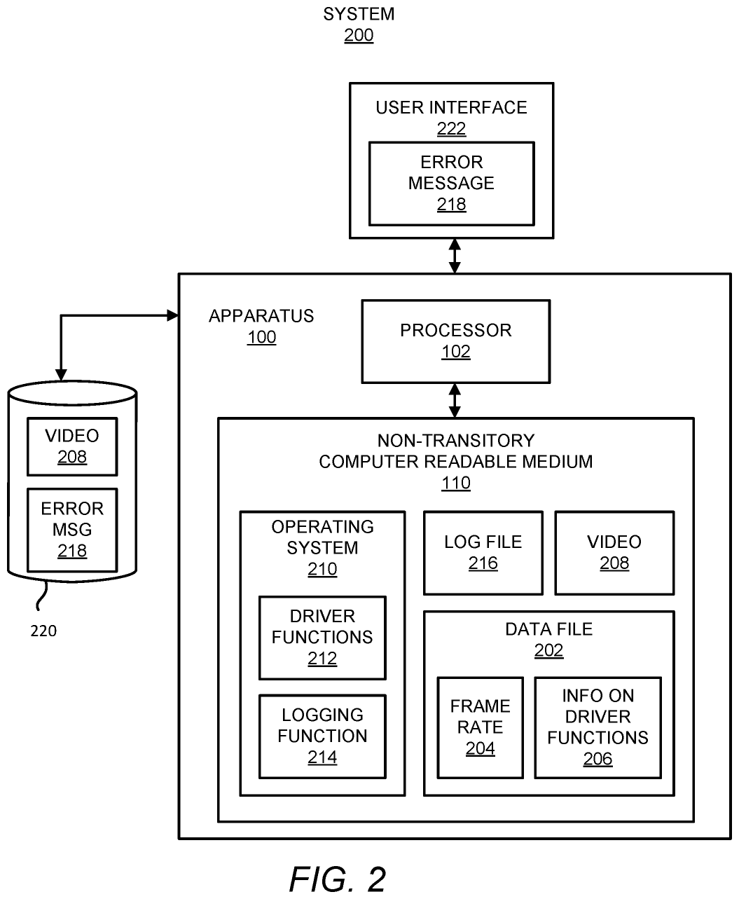

Reference is first made to FIGS. 1 and 2. FIG. 1 shows a block diagram of an example apparatus 100 that may determine a cause of a video glitch and may output an error message that includes information associated with the cause of the video glitch. FIG. 2 shows a block diagram of an example system 200 in which the example apparatus 100 depicted in FIG. 1 may be implemented. It should be understood that the example apparatus 100 depicted in FIG. 1 and the example system 200 depicted in FIG. 2 may include additional features and that some of the features described herein may be removed and/or modified without departing from the scopes of the apparatus 100 and/or the system 200.

The apparatus 100 may be a server, a node in a network (such as a data center), a personal computer, a laptop computer, a tablet computer, a smartphone, a network gateway, a network router, an electronic device such as Internet of Things (IoT) device, and/or the like. As shown, the apparatus 100 may include a processor 102 and a non-transitory computer-readable medium 110. The processor 102 may be a semiconductor-based microprocessor, a central processing unit (CPU), an application specific integrated circuit (ASIC), a field-programmable gate array (FPGA), and/or other hardware device. Although the apparatus 100 is depicted as having a single processor 102, it should be understood that the apparatus 100 may include additional processors and/or cores without departing from a scope of the apparatus 100. In this regard, references to a single processor 102 as well as to a single computer-readable medium 110 may be understood to additionally or alternatively pertain to multiple processors 102 and/or multiple computer-readable mediums 110.

The non-transitory computer-readable medium 110 may be an electronic, magnetic, optical, or other physical storage device that contains or stores executable instructions. The non-transitory computer-readable medium 110 may be, for example, Read Only Memory (ROM), flash memory, solid state drive, Random Access memory (RAM), an Electrically Erasable Programmable Read-Only Memory (EEPROM), a storage device, an optical disc, or the like. The term “non-transitory” does not encompass transitory propagating signals.

As shown in FIG. 1, the processor 102 may execute instructions 112-118 to determine a cause of a video glitch. The instructions 112-118 may be machine-readable instructions, e.g., non-transitory computer-readable instructions. In other examples, the apparatus 100 may include hardware logic blocks or a combination of instructions and hardware logic blocks to implement or execute functions corresponding to the instructions 112-118.

The processor 102 may fetch, decode, and execute the instructions 112 to access a data file 202 that may include, for example, a frame rate 204 and information regarding driver functions 206 associated with driver threads executing during playback of a video 208. The data file 202 may include, for instance, information logged by a utility in an OS 210. By way of example, the OS 210 may be a system software that manages computer hardware and software resources. In these examples, the OS 210 may concurrently execute multiple processes for different applications, together with a process specific to rendering the video 208. In some examples, the OS 210 may include code for driver functions 212, which may be code associated with interrupts and prioritization of tasks at the system level to facilitate concurrent execution of multiple processes. In some examples, because multiple processes may concurrently be executing with the process for video rendering, implementation of driver functions 212 in a plurality of driver threads by the OS 210 may delay the process for rendering the video 208 and thus may cause glitches to appear during playback of the video 208.

As used herein, driver functions 212 may refer to OS 210 functions such as, for example, ISR, DPC, or the like. An ISR may be associated with specific interrupt conditions, which hardware and/or software may initiate, such as a third party device driver, and a DPC may prioritize various tasks (e.g., ISRs). In some examples, multiple driver threads may execute for a particular process (e.g., a process for video rendering) and multiple driver functions 212 may be associated with a particular driver thread for the process. In this example, the durations and frequencies of these driver functions 212 in a particular driver thread may be associated with video glitches.

By way of example, in each driver thread, a length of time required to execute a particular driver function 212 may be associated with delays in processing the driver thread (e.g., long interrupt). In this example, when the length of time for executing the particular driver function 212 is longer than a predefined length of time, the interruption in executing the driver thread caused by the particular driver function 212 may be associated with a video glitch. Likewise, in some examples, when a large number of driver functions 212 are present in a particular driver thread in a relatively short period of time, the cumulative interruptions in executing the driver thread caused by each of the plurality of driver functions 212 may be associated with a video glitch (e.g., heavy interrupt).

The presence of long or heavy interrupts may cause defects during rendering of the video 208, for example, defects to vertical synchronization or V-sync signals. V-sync pulses may be generated at a beginning of each frame of a video and may be correlated with a refresh rate of a display. In this example, a video glitch or stutter in the displayed video may occur when the frame rate of the video falls below the refresh rate of the display, and the presence of the long or heavy driver functions 212 may cause such defects in V-sync, which in turn may cause a video glitch.

As such, identification of such driver functions 212, which may be associated with a video glitch, for each driver thread of a process executed within the OS 210, may facilitate determination of causes of video glitches during playback of the video 208. The driver functions 212 in each driver thread may be captured using a logging function 214 included in the OS 210. The logging function 214 may be a utility of the OS 210 to log events of the OS 210 and may track system-wide component interactions, which may be used for debugging various system errors. The logging function 214 may log various types of information including, for example, the frame rate 204 of the video 208 during playback and information 206 on driver functions 212. In particular examples, the logging function 214 may be tools provided the by the OS 210 for event tracing such as an event trace log (ETL), an Event Tracing for Windows® (ETW), and/or the like.

In some examples, the processor 102 may activate the logging function 214 of the OS 210 to generate a log file 216. The log file 216 may be in a particular format based on the logging function 214. In particular examples, the log file 216 generated by ETL may be saved in a .etl file format.

In some examples, the processor 102 may initiate playback of the video 208 after the logging function 214 has been activated. In these examples, the logging function 214 may log events during rendering of the video 208 such as frame rate 204 of the video 208 during playback and information 206 on driver functions 212 such as an execution time of each driver function 212 in a particular driver thread. The processor 102 may also save the log file 216 generated by the logging function 214. By way of example, the processor 102 may save the log file 216 at a particular point in time such as after the playback of the video 208 has completed, updated in real-time corresponding to real-time capture of the video 208, saved at predefined intervals, saved in response to a particular event such as an error condition, and/or the like.

In some examples, the processor 102 may translate the log file 216 to a data file 202. The data file 202 may be a file having a text format that may facilitate sorting and parsing of the data included in the log file 216. In particular examples, the log file 216 may be translated from a .etl file to a .csv file, or another appropriate type of file having a particular format based on the implementation.

The processor 102 may fetch, decode, and execute the instructions 114 to determine whether the frame rate 204 is less than a predefined frame rate. The processor 102 may access the data file 202 to analyze the frame rate 204 of the video 208 during playback and information 206 regarding driver functions 212 associated with driver threads executing during playback of the video 208. In some examples, the logging function 214 may capture a plurality of driver threads for various processes, and each of the plurality of driver threads may include a plurality of driver functions 212 that may interrupt the execution of the driver threads. In these examples, for each driver thread, the processor 102 may determine whether the frame rate 204 of the video 208 is less than the predefined frame rate. In particular examples, the predefined frame rate may be determined through experimentation, testing, and/or the like. By way of particular example, the predefined frame rate may be about 60 fps.

The processor 102 may fetch, decode, and execute the instructions 116 to, based on a determination that the frame rate 204 is less than the predefined frame rate, determine whether an execution time of a particular (e.g., first) driver function 212 exceeds a first predefined length of time. In particular examples, the predefined length of time may be determined through experimentation, testing, and/or the like. By way of particular example, the predefined length of time may be about 3 milliseconds (ms).

The occurrence of a drop in frame rate 204 may coincide with or occur in proximity to a driver function 212 or multiple driver functions 212 that execute for a relatively long period of time (e.g., long interrupt), and which may cause the drop in frame rate 204. In some examples, for each driver thread, the processor 102 may determine each driver function 212 that exceeds the predefined length of time, and for each occurrence, the processor 102 may increment a counter (not shown). In a particular example, the processor 102 may increment the counter upon the occurrence of either a single ISR or DPC in the driver thread that exceeds the predefined length of time. That is, for example, either a long ISR or a long DPC may increment the counter.

The processor 102 may fetch, decode, and execute the instructions 118 to, based on a determination that the execution time of the particular driver function 212 exceeds the first predefined length of time, output an error message 218 that may include information associated with the particular driver function 212. As used herein, the error message 218 may be referred to as a long interrupt error message. In particular examples, the long interrupt error message 218 may include an identification or description of the driver function 212 and a name of a driver (not shown) associated with the driver function 212. In this regard, the processor 102 may determine the name of the driver associated with the identified driver function 212 based on information contained in the data file 202, from a table in a database 220, or the like. The long interrupt error message 218 may also include the counter, which may indicate a number of occurrences of long driver function errors identified in the driver thread.

In some examples, the processor 102 may output the long interrupt error message 218 to a user interface 222, such as a computer display, or the like. Alternatively, or in addition, the processor 102 may output the error message 218 to a file stored in the computer-readable medium 110 or the database 220, which may later be accessed.

In some examples, based on the determination that the frame rate 204 is less than the predefined frame rate as previously described, the processor 102 may determine whether a sum of execution times of multiple driver functions 212 in a driver thread exceeds a second predefined length of time within a predefined time period. In particular examples, the second predefined length of time and the predefined time period may be determined through experimentation, testing, and/or the like. By way of particular example, the second predefined length of time may be about 4 ms and the predefined time period may about 10 ms. The processor 102 may determine the sum of execution time of multiple driver functions 212 concurrently with the determination of the execution time of a particular driver function or alternatively to the determination of the execution time of a particular driver function.

An occurrence of a drop in the frame rate 204 may coincide with or occur in proximity to a plurality of driver functions 212 occurring within a window of time and having cumulative execution times that exceed a second predefined length of time (e.g., heavy interrupt). In some examples, the processor 102 may determine such a group of driver functions 212 to be the cause of the drop in the frame rate 204. In some examples, for each driver thread, the processor 102 may determine an execution time for each driver function 212 within a predefined time period. When a sum of the execution times of the driver functions 212 within the predefined time period exceeds the second predefined length of time, for each such occurrence, the processor 102 may increment a counter. In particular examples, the driver functions 212 may be ISRs or DPCs and an execution time of any one ISR and/or DPC may be counted towards the total execution time. In some examples, the predefined time period may be a moving window, and the processor 102 may identify a heavy interrupt error as described herein in real-time.

In some examples, the processor 102 may output an error message 218 that may include information associated with the determined plurality of driver functions 212. As used herein, the error message 218 may be referred to as a heavy interrupt error message. In particular examples, the heavy interrupt error message 218 may include an identification or description of each of the driver functions 212 and names of drivers associated with the identified driver functions 212. In this regard, the processor 102 may determine the names of the drivers associated with the driver functions 212 based on information contained in the data file 202, from a table in a database 220, or the like. In some examples, the heavy interrupt error message 218 may include a counter indicating a number of occurrences of heavy driver function errors identified in the driver thread.

A particular driver function 212 may trigger an error for both the long interrupt error as previously described as well as the heavy interrupt error. That is, for example, an execution time fora particular driver function 212 may exceed a predefined length of time (e.g., greater than 4 ms) thereby triggering both types of errors, and the information for the particular driver function 212 may be included in both the error message 218 for long interrupts and the error message 218 for heavy interrupts.

The processor 102 may output the heavy interrupt error message 218 to a user interface 222, such as a computer display, or the like. Alternatively, or in addition, the processor 102 may output the heavy interrupt error message 218 to a file stored in the computer-readable medium 110 or the database 220, which may later be accessed. In some examples, the heavy interrupt error message 218 may be output together with the long interrupt error message 218, for example, to be displayed together on the user interface 222 or saved as a single file on the database 220.

As previously described, the processor 102 may initiate playback of the video 208 retrieved from the computer-readable medium 110. In some examples, the video 208 may be stored on the database 220, on a server on a network (not shown), or the like, and the processor 102 may access the video 208 from the database 220 or server for playback on the apparatus 100. However, in other examples, the video 208 may be streamed during playback.

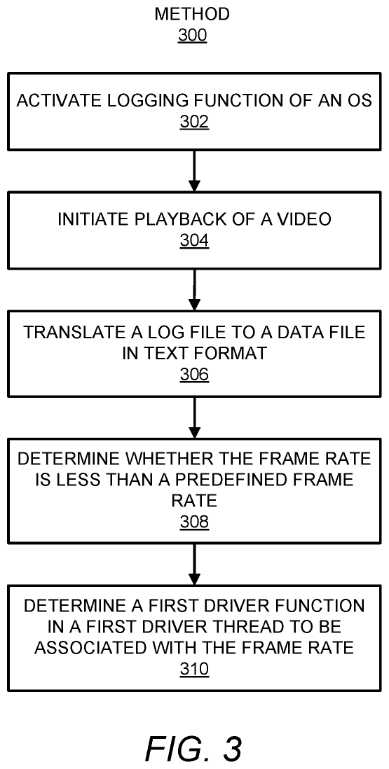

Turning now to FIG. 3, there is shown a flow diagram of an example method 300 for generating a data file for determining a first driver function in a first driver thread to be associated with a frame rate of a video playback that is less than a predefined frame rate, e.g., determining a cause of a video glitch in a playback of the video. It should be understood that the method 300 depicted in FIG. 3 may include additional operations and that some of the operations described therein may be removed and/or modified without departing from the scope of the method 300. The description of the method 300 is also made with reference to the features depicted in FIGS. 1-2 for purposes of illustration. Particularly, the processor 102 of the apparatus 100 may execute some or all of the operations included in the method 300.

At block 302, the processor 102 may activate a logging function 214 of an OS 210. The OS 210 may provide the logging function 214 and the logging function 214 may capture events including driver threads and driver functions 212 included in each of the driver threads. In some examples, the logging function 214 may be a program such as ETL or ETW implemented within the OS 210.

At block 304, the processor 102 may initiate playback of a video 208. The video 208 may be stored on the computer-readable medium 110 of the apparatus 100, the database 220, on a remote server, or the like. In some examples, the video 208 may be a video clip or a representative video clip used for testing the apparatus 100 or for reproducing a video glitch that is rendered on the apparatus 100.

In some examples, the processor 102 may capture the video 208 during playback in real time. In addition, the logging function 214 may generate a log file 216 and the processor 102 may save the log file 216. The processor 102 may control the logging function 214 to output the log file 216, and the log file 216 may be output in a file format corresponding to the logging function 214. In particular examples, the log file 216 may be output from the logging function 214 and saved as a .etl file.

At block 306, the processor 102 may translate the log file to a data file 202 having a text format. In some examples, the log file 216 may include a frame rate 204 of the playback of the video 208 and information 206 regarding execution of driver functions 212 associated with driver threads. In some examples, the processor 102 may sort and parse the data file 202 for information related to the playback of the video 208, such as the frame rate 204 and information regarding driver functions 212 associated with the frame rate 204.

At block 308, the processor 102 may determine, based on the data file 202, whether the frame rate 204 of the video playback is less than a predefined frame rate. In some examples, the predefined frame rate may be determined based on experimentation, testing, or the like. In a particular example, the predefined frame rate may be determined to be about 60 fps.

At block 310, the processor 102 may determine a first driver function 212 in a first driver thread to be associated with the frame rate 204. In some examples, the first driver function 212 may be determined to be associated with the frame rate 204 when the frame rate 204 coincides with a determined drop in the frame rate 204 below the predefined frame rate. In some examples, the first driver function 212 may be determined to be associated with the frame rate 204 when an execution time for the first driver function 212 exceeds a predefined length of time. The processor 102 may also identify a driver associated with the first driver function 212 and may output a first error message 218 that includes the first driver function 212 and a name of the driver associated with the first driver function 212.

Alternatively, or in addition, the processor 102 may determine whether a sum of execution times of second driver functions 212 in the first driver thread exceeds a second predefined length of time within a predefined time period. In some examples, the processor 102 may determine the second driver functions 212 to be associated with the frame rate 204, in which the first driver function 212 may be included among the second driver 212 functions and may be used to determine the sum of execution times. In some examples, the processor 102 may identify second drivers associated with the second driver function 212 and may output a second error message 218 that may include the second driver functions 212 and names of the drivers associated with the second driver functions 212.

The first driver function 212 and/or the second driver function 212 may be an ISR or a DPC that may execute in a driver thread among a plurality of driver threads. The processor 102 may repeat the operations at block 310 for each driver thread among the plurality of driver threads.

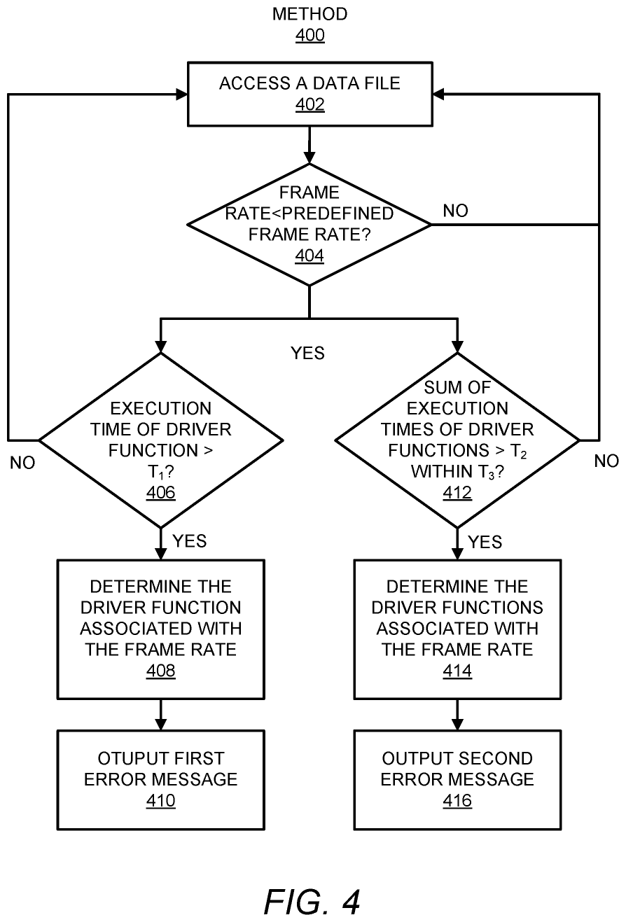

Turning now to FIG. 4, there is shown a flow diagram of an example method 400 for determining a driver function or multiple driver functions to be associated with a frame rate of a video playback that is less than a predefined frame rate, e.g., determining a cause of a video glitch in a playback of the video. It should be understood that the method 400 depicted in FIG. 4 may include additional operations and that some of the operations described therein may be removed and/or modified without departing from the scope of the method 400. The description of the example method 400 is also made with reference to the features of the example apparatus 100 and the example system 200 as depicted FIGS. 1-2 and the example method depicted in FIG. 3 for purposes of illustration. Particularly, the processor 102 of the apparatus 100 may execute some or all of the operations included in the example method 400, and the example method 400 may include some or all of the operations of the example method 300 depicted in FIG. 3.

At block 402, the processor 102 may access a data file 202. The data file 202 may be stored on the computer-readable medium 110, the database 220, or another appropriate device such as a remote server, or the like. The data file 202 may have a text format that may facilitate sorting and parsing of the data included in the data file 202. In some examples, the data file 202 may include a frame rate 204 of the playback of the video 208 and information 206 regarding execution of driver functions 212 associated with a plurality of driver threads.

At block 404, the processor 102 may determine from the data file 202 whether the frame rate 204 of the video playback is less than a predefined frame rate. In some examples, the predefined frame rate may be determined based on experimentation, testing, or the like. By way of particular example, the predefined frame rate may be determined to be about 60 fps. In instances in which the frame rate 204 is above about 60 fps in each of the threads, the processor 102 may again access the data file 202 for updated data or access another data file 202.

At block 406, based on the frame rate 204 being below the predefined frame rate at block 404, the processor 102 may determine whether an execution time of a first driver function 212 exceeds a first predefined length of time T₁. In some examples, the first predefined length of time T₁ may be about 3 ms.

At block 408, based on the execution time of the first driver function 212 exceeding the first predefined length of time T₁, the processor 102 may determine the first driver function 212 that is associated with the frame rate 204. In some examples, the processor 102 may determine that the first driver function 212 is to be associated with the frame rate 204 in any of the manners as described herein. However, based on the execution time of the first driver function 212 falling below the first predefined length of time T₁, the processor 102 may again access the data file 202 for updated data or access another data file 202 and may repeat blocks 404 and 406.

At block 410, the processor 102 may output a first error message 218, which may include the first driver function 212 and a name of a driver associated with the first driver function 212. In some examples, the first error message 218 may include a counter indicating a number of different first driver functions 212 that triggered the error, e.g., video glitch.

In addition or alternatively to block 406, at block 412, based on the frame rate 204 being below the predefined frame rate at block 404, the processor 102 may determine whether a sum of execution times of a second driver function 212 exceeds a second predefined length of time T₂ within a predefined time period T₃. In some examples, the second predefined length of time T₂ may be about 4 ms and the predefined time period T₃ may be about 10 ms.

At block 414, based on the sum of execution times of the second driver functions 212 exceeding the second predefined length of time T₂, the processor 102 may determine the second driver functions 212 that are associated with the frame rate 204. In some examples, the processor 102 may determine that the second driver functions 212 are to be associated with the frame rate 204 in any of the manners as described herein. However, based on the sum of the execution times of the second driver functions 212 falling below the second predefined length of time T₂, the processor 102 may again access the data file 202 for updated data or access another data file 202 and may repeat blocks 404 and 412.

At block 416, the processor 102 may output a second error message 218, which may include the second driver functions 212 and names of drivers associated with the second driver functions 212. In some examples, the second error message 218 may include a second counter indicating a number of different instances in which a group of second driver functions 212 triggered the error.

In some examples, the processor 102 may repeat operations 402-410 and/or operations 402, 404, and 412-418 for each thread among a plurality of threads. The first driver function 212 identified in operation 406 may also trigger an error in operation 412. That is, for instance, a particular driver function 212 may trigger both a long interrupt error and a heavy interrupt error. In some examples, the processor 102 may execute the operations 406-410 to detect and output, for example, a long interrupt error and the operations 412-416 to detect and output, for example, a heavy interrupt error, concurrently, simultaneously, sequentially, and/or independently.

Some or all of the operations set forth in the methods 300 and 400 may be included as utilities, programs, or subprograms, in any desired computer accessible medium. In addition, the methods 300 and 400 may be embodied by computer programs, which may exist in a variety of forms both active and inactive. For example, they may exist as machine-readable instructions, including source code, object code, executable code or other formats. Any of the above may be embodied on a non-transitory computer-readable storage medium.

Examples of non-transitory computer-readable storage media include computer system RAM, ROM, EPROM, EEPROM, and magnetic or optical disks or tapes. It is therefore to be understood that any electronic device capable of executing the above-described functions may perform those functions enumerated above.

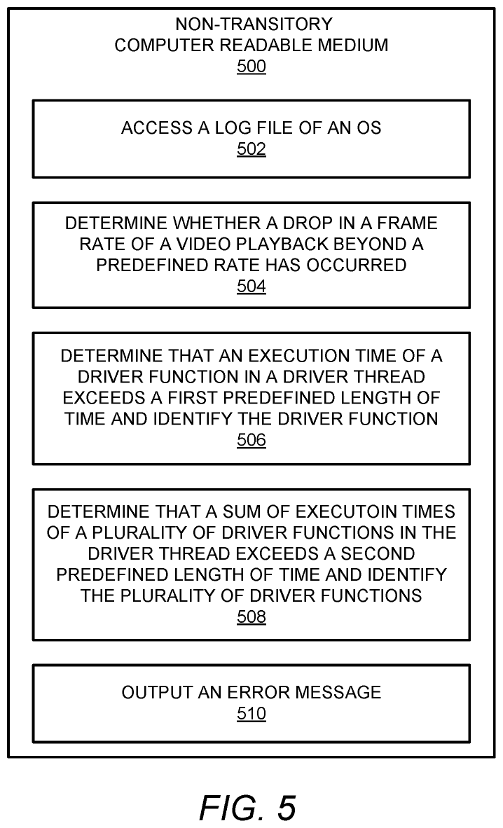

Turning now to FIG. 5, there is shown a block diagram of a non-transitory computer-readable medium 500 that may have stored thereon machine-readable instructions for determining a driver function or multiple driver functions to be associated with a frame rate of a video playback that is less than a predefined frame rate, e.g., determining a cause of a video glitch in a playback of the video. It should be understood that the computer-readable medium 500 depicted in FIG. 5 may include additional instructions and that some of the instructions described herein may be removed and/or modified without departing from the scope of the computer-readable medium 500 disclosed herein. The computer-readable medium 500 may be a non-transitory computer-readable medium. The term “non-transitory” does not encompass transitory propagating signals. The description of the non-transitory computer-readable medium 500 is also made with reference to the features depicted in FIGS. 1-2 for purposes of illustration. Particularly, the processor 102 of the apparatus 100 may execute some or all of the instructions 502-510 included in the non-transitory computer-readable medium 500.

The computer-readable medium 500 may have stored thereon machine-readable instructions 502-510 that a processor, such as the processor 102 depicted in FIGS. 1 and 2, may execute. Particularly, the processor 102 may execute instructions 502 to access a log file 216 of an OS 210. The processor 102 may execute instructions 504 to determine, from the accessed log file 216, whether a drop in a frame rate 204 of a video 208 playback beyond a predefined drop level has occurred.

Based on the determination that the drop in the frame rate 204 beyond the predefined drop level has occurred, the processor 102 may execute instructions 506 to determine that an execution time of a driver function 212 in a driver thread exceeds a first predefined length of time and may identify the driver function 212 to be associated with the drop in the frame rate 204. Alternatively, or in addition, in some examples, the processor 102 may execute instructions 508 to determine that a sum of execution times of a plurality of driver functions 212 in the driver thread exceeds a second predefined length of time and may identify the plurality of driver functions 212 to be associated with the drop in the frame rate 204. The processor 102 may execute instructions 510 to output an error message 218 including the identified driver function 212 or the identified plurality of driver functions 212. In some examples, the first driver function 212 may be ISR or a DPC that may execute in the driver thread.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a non-transitory computer-readable medium on which is stored instructions that, when executed by the processor, are to cause the processor to:
access a data file, the data file including a frame rate of a video and information regarding driver functions associated with driver threads executing during playback of the video;
determine whether the frame rate is less than a predefined frame rate;
based on a determination that the frame rate is less than the predefined frame rate, determine whether an execution time of a first driver function exceeds a first predefined length of time; and
based on a determination that the execution time of the first driver function exceeds the first predefined length of time, output a first error message that includes information associated with the first driver function.

2. The apparatus of claim 1, wherein the instructions are further to cause the processor to:
based on the determination that the frame rate is less than the predefined frame rate, determine whether a sum of execution times of second driver functions in a driver thread exceeds a second predefined length of time within a predefined time period; and
based on a determination that the sum of execution times of the second driver functions exceeds the second predefined length of time within the predefined time period, output a second error message that includes information associated with the second driver functions.

3. The apparatus of claim 2, wherein the instructions are further to cause the processor to:
determine that the sum of execution times of the second driver functions exceeds the second predefined length of time when the sum of execution times for each of the second driver functions exceeds about 4 milliseconds (ms) within about a 10 ms time period.

4. The apparatus of claim 2, wherein the instructions are further to cause the processor to:
based on the execution time of the first driver function exceeding the first predefined length of time, increment a first counter associated with the first error message;
output the first counter in the first error message;
based on the sum of execution times of the second driver functions in the driver thread exceeding the second predefined length of time within the predefined time period, increment a second counter associated with the second error message; and
output the second counter in the second error message.

5. The apparatus of claim 1, wherein the instructions are further to cause the processor to:
activate a logging function of an operating system;
initiate playback of the video;
save a log file output from the logging function, the log file including the frame rate during playback of the video and the information regarding the driver functions associated with the driver threads executing during playback of the video; and
translate the log file to the data file having a text format.

6. The apparatus of claim 1, wherein the first driver function is an interrupt service routine (ISR) or a deferred procedure call (DPC) of an operating system.

7. The apparatus of claim 1, wherein the instructions are further to cause the processor to:
determine that the execution time of the first driver function exceeds the first predefined length of time when the execution time of the first driver function exceeds about 3 ms.

8. The apparatus of claim 1, wherein the information associated with the first driver function includes an identification of the first driver function and a name of a first driver associated with the first driver function.

9. A method comprising:
activating, by a processor, a logging function of an operating system;
initiating, by the processor, playback of a video, wherein the logging function is to output a log file corresponding to the playback of the video;
translating, by the processor, the log file to a data file having a text format, the log file including a frame rate of the playback of the video and information regarding execution of driver functions associated with driver threads;
determining, by the processor and from the data file, whether the frame rate of the video playback is less than a predefined frame rate; and
determining, by the processor and based on a determination that the frame rate of the video playback is less than the predefined frame rate, a first driver function in a first driver thread to be associated with the frame rate.

10. The method of claim 9, comprising:
determining whether an execution time of the first driver function exceeds a first predefined length of time; and
determining the first driver function to be associated with the frame rate based on the determination of whether the execution time of the first driver function exceeds the first predefined length of time.

11. The method of claim 9, further comprising:
identifying a driver associated with the first driver function; and
outputting a first error message that includes the first driver function and a name of the driver associated with the first driver function.

12. The method of claim 9, further comprising
based on the determination that the frame rate is less than the predefined frame rate, determining whether a sum of execution times of second driver functions in the first driver thread exceeds a second predefined length of time within a predefined time period;
based on a determination that the sum of execution times of the second driver functions exceeds the second predefined length of time within the predefined time period, determining the second driver functions to be associated with the frame rate; and
outputting a second error message that includes the second driver functions names of drivers associated with the second driver functions.

13. The method of claim 9, wherein the first driver function is an interrupt service routine (ISR) or a deferred procedure call (DPC) that execute in a driver thread among the driver threads.

14. A non-transitory computer-readable medium on which is stored machine-readable instructions that when executed by a processor, cause the processor to:
access a log file of an operating system;
determine, from the accessed log file, whether a drop in a frame rate of a video playback beyond a predefined drop level has occurred;
based on the determination that the drop in the frame rate beyond the predefined drop level has occurred,
determine that an execution time of a driver function in a driver thread exceeds a first predefined length of time and identify the driver function to be associated with the drop in the frame rate; and/or
determine that a sum of execution times of a plurality of driver functions in the driver thread exceeds a second predefined length of time and identify the plurality of driver functions to be associated with the drop in the frame rate; and
output an error message including the identified driver function or the identified plurality of driver functions.

15. The non-transitory computer-readable medium of claim 14, wherein the first driver function is an interrupt service routine (ISR) or a deferred procedure call (DPC) that executes in the driver thread.
